(19) United States
(12) Patent Application Publication
(10) Pub. No.: US 2026/0278193 A1
(43) Pub. Date: Sep. 17, 2026

(54) METHOD FOR PLANNING AND CONSTRUCTION OF WALLS WITH EASILY-INSTALLABLE WALL PANELS

(71) Applicant: KPS GLOBAL LLC, Fort Worth, TX (US)

(72) Inventors: Justin Potter, Springtown, TX (US); Jeo James, Keller, TX (US); Mike Eakins, Fort Worth, TX (US); Bryan McCauley, Grapevine, TX (US); Humberto Hernandez, North Richland Hills, TX (US); Bunhap Sam, Fort Worth, TX (US); David J. Walker, Buckeye, AZ (US); Lun Tsuei, Dallas, TX (US); Anand Kulkarni, Fort Worth, TX (US); Omar Gonzalez, Goodyear, AZ (US); Martin Trejo, Buckeye, AZ (US)

(21) Appl. No.: 19/678,867

(22) Filed: May 15, 2026

Related U.S. Application Data
(63) Continuation of application No. PCT/US24/55833, filed on Nov. 14, 2024.
(60) Provisional application No. 63/600,405, filed on Nov. 17, 2023.

(51) Int. Cl. G06F 30/13; E04B 2/00

(52) U.S. Cl. CPC G06F 30/13; E04C 2/46

(57) ABSTRACT

A process for determining a number and distribution of wall panels to be assembled into wall spans to form rooms in accordance with a floor plan, so as to accommodate pre-installation of multiple junction boxes, in a manner that maximizes efficiency in the standardization of wall panel manufacture despite complexities in the number and location of such junction boxes.

### CROSS-SECTION TO RELATED APPLICATION

This application is a Continuation of International Patent Application No. PCT/US24/55833, filed Nov. 14, 2024, which claims the benefit of the filing date of U.S. Provisional Application No. 63/600,405, filed Nov. 17, 2023, the entirety of which is hereby incorporated by reference.

### FIELD

This disclosure relates generally to the planning and construction of walls using wall panels that are easily installable and, more particularly, to the design and production of a series of wall panels of varying complexity to accommodate requirements of a particular job, and manufacturing and ordering of such wall panels so as to be deployed in an order facilitating installation.

### BACKGROUND

Wall panels have been used in the construction of interior walls in commercial spaces. However, existing systems for planning, assembling, distributing, and installing wall panels are inefficient and do not adequately address practical considerations such as custom in-wall electrical, data, plumbing, and HVAC requirements that are known prior to installation of the walls. Forward compatibility, in the form of wall panels designed to accommodate future in-wall electrical, data, plumbing, and HVAC requirements, is another feature that, while attempts have been made in the past to address, could benefit from further advancements. There is a need for a system and method for efficiently planning and implementing a panel system for commercial spaces.

Moreover, installation of wall panels of varying size and/or components often requires space-intensive laying out of the wall panels by installers prior to installation to assure proper positioning of wall panels when assembling a wall. Methodologies that permit ordering of wall panels for shipment to an installation site in a manner that facilitates wall assembly without the need to lay out most or all wall panels prior to installation would be beneficial.

### SUMMARY

When planning a wall panel installation project for a commercial space, an initial layout drawing typically includes a floorplan with room dimensions. In that same drawing, or in a schematic addendum, the locations of junction boxes to position electrical outlets, light switches, access card readers, and other in-wall electrical, data, plumbing, and HVAC requirements are specified. In some rooms, the tolerances on such locations is rather loose, in that the junction boxes, for instance, can be located within several inches of the positions designated on the schematic drawing and still satisfy the requirements of the architect and applicable building code requirements. In other rooms, tolerances are relatively tight, with little latitude for deviation from the precise locations specified on the schematic drawing.

The vertical height of junction boxes used for most electrical outlets is a standard default height, often dictated by building codes. For instance, 12 inches, 16 inches, or 18 inches (measured from the top of the floor to the bottom of the junction box) are typical default heights for a junction box. Typical heights for junction boxes used for light switches are 44 inches to 48 inches. The number of junction boxes and other in-wall plumbing and HVAC requirements can vary from wall span to wall span.

By planning a wall panel installation project that is based on the number and location of junction boxes, and other intricacies, of each span of wall to be constructed in panels, the wall panels needed for an efficient installation can be predicted with greater accuracy, and constructed in a manner that maximizes efficiency in both labor and materials. Furthermore, with attention to the order in which wall panels are to be installed, packing manufactured wall panels for shipment can facilitate installation.

A standard length of a wall panel for a span of wall in a commercial space is 47 inches. A wall panel may be entirely foamed-in, or may include an open side, or chase region, to accommodate post-installation customization, such as electrical wiring, plumbing, HVAC, or other conduits, and a foamed-in side. The perimeter or frame of each wall panel is formed by a pair of vertical struts made of plywood or other suitable materials, as well as top and bottom (horizontal) struts, also made of plywood or other suitable materials. For wall panels that include an interior chase region, there would be a vertical divider separating the foamed-in side from the interior chase region, which divider is also made of plywood or other suitable materials.

The complexity of manufacturing each individual wall panel ranges based on a variety of factors. The easiest wall panel to manufacture is a wall panel having a standard length (e.g., 47″) and an entirely foamed-in core, with no junction boxes or conduits. For purposes of the present disclosure, such a wall panel is designated as having a manufacturing complexity level of 0. A wall panel having the standard length but both a foamed-in core portion and a chase region, separated by a vertical divider a predetermined uniform distance from one of the vertical side struts, e.g., 16 inches, with no junction boxes or conduits, is designated for purposes of the present disclosure as having a manufacturing complexity level of 1. A non-standard length wall panel that is fully foamed-in and has no junction boxes or conduits is also designated for purposes of the present disclosure as having a manufacturing complexity level of 1.

The foamed side of one of the vertical struts at the sides of a standard-length wall panel, and the foamed side of a vertical divider of a wall panel having an unfoamed chase region, provide the easiest vertical supports to which junction boxes may be attached. Wall panels having one or two junction boxes, and if two, both of which are to be open to the same surface of the wall panel, are, for purposes of the present disclosure, designated as having a manufacturing complexity level of 2.

If junction boxes must be secured to other locations within a wall panel, the wall panel is more complicated to manufacture, as it may require additional vertical struts, or provide additional structural elements within a chase region of the wall panel, to accommodate the junction boxes. Therefore, wall panels having one or more junction boxes that are to be installed at locations other than on the foamed-in side of a vertical strut or divider of a wall panel, or at other than a standard height, is designated for purposes of the present disclosure as having a manufacturing complexity level of 3. Junction boxes that are to be accessible from both exposed surfaces of the wall panel, e.g., to accommodate back-to-back electrical outlets in the shared wall of two adjoining rooms, do not significantly increase the manufacturing complexity of a wall panel, but the need to accommodate separate junction boxes, at least one of which is exposed to a first surface of the wall panel and at least one of the other junction boxes is exposed to a second, opposite surface of the wall panel, would increase the manufacturing complexity of a wall panel. For purposes of the present disclosure, wall panels that are to have two or more distinct junction boxes, at least one of which is to be exposed to a first surface and at least one of which is to be exposed to a second, opposite surface, are designated as having a manufacturing complexity level of 4.

Efficient manufacture of wall panels can be maximized by standardizing the wall panels to the greatest extent possible. While it is recognized that not all wall panels for a particular span of wall will be able to satisfy the requirements of a particular job and be manufactured at a manufacturing complexity level of 0 or 1, there are benefits to designing an arrangement of wall panels in a manner that minimizes the cumulative manufacturing complexity level of all of the wall panels necessary for assembling each span of wall for a job.

As used herein, a span of wall is considered to be the distance in a horizontal direction from a corner of a room to the next corner on either surface of that wall span. For instance, where two adjacent rooms share a common wall, a span of the shared wall would extend from a first corner of one of the rooms to the nearest corner of either of the rooms, even if the rooms do not share one or more corners.

In designing and manufacturing a set of wall panels for a particular project, a method of the present disclosure includes receiving a general architectural layout or floorplan for one or more rooms of a site, such as a commercial structure in which walls defining one or more rooms are to be constructed. The general architectural layout or floorplan may include schematics of locations of electrical outlets, light switches, data line jacks, plumbing, and HVAC, or those schematics may be provided on one or more additional drawings. The schematic drawings should indicate, or the manufacturer of the wall panels should otherwise be provided with, tolerances for at least the horizontal, but preferably also the vertical, locations of each junction box and other conduit to be provided in the walls of the rooms represented in the general architectural layout. For purposes of this disclosure, the intricacies of wall panels discussed is limited to junction boxes. However, it will be understood that the principles described herein additionally apply to other pre-installed components, such as plumbing, fire suppression systems, and/or HVAC conduit.

Next, the layout is analyzed to identify each wall span that is to be built using wall panels. For each wall span, a length of the wall span is calculated and divided by the standard length of a wall panel for a span of wall in a commercial space, such as 47 inches. It is recognized that each corner of a span of wall may include a wall panel having a length that is less than the standard length, with each such wall panel closest to the corner being a special wall panel with characteristics that are required only for such corner wall panels. As such, the lengths of both corner wall panels in the span of wall should be subtracted before dividing by the standard length of a wall panel. As in the case of corner wall panels, regions of a wall that accommodate other openings, such as service counter openings, windows, stairwells, doorways (including bay doors), or elevator doors, referred to herein as interruptions, are also subtracted from the wall span before dividing by the standard length of a wall panel. A nominal number of standard-length wall panels for the wall span is the largest whole number that is less than or equal to the quotient of the length of the wall span divided by the standard length of a wall panel.

The architectural layout of the room(s) for which the wall span is to be constructed, or a schematic drawing including the locations of junction boxes to be provided in that wall span (if those locations are on a separate drawing), is analyzed to determine the desired locations of junction boxes and other components to be preinstalled in the wall span, as well as the horizontal and, if available, vertical tolerances of those locations.

A nominal complexity level for the span of wall is then calculated by creating a virtual representation of the nominal number of standard-length wall panels arranged in a row (with a first of the represented standard length wall panels positioned closest to a first corner of the span of wall), and superimposing that virtual representation with a drawing indicating the desired locations of junction boxes to be preinstalled in the wall span. A number of junction boxes in each virtually represented standard-length wall panel along the wall span is then determined. Next, as to each junction box, it is determined whether the location of the junction box along the wall span is at, or within that junction box's tolerance of, a foamed-in side of a vertical strut or a divider of one of the virtually represented wall panels.

Next, it is determined whether any of the virtually represented standard-length wall panels would include at least one junction box that is to be exposed on a first surface of the wall span and at least one other junction box that is to be exposed on a second, opposite surface of the wall span.

Each virtually represented standard-length wall panel is then assigned a manufacturing complexity level, based on the manufacturing complexity level rubric described above. The number of virtually represented wall panels at each manufacturing complexity level is multiplied by their respective manufacturing complexity level, and the total is a nominal cumulative manufacturing complexity level for the set of virtually represented standard-sized wall panels. If the location of a junction box is not at a foamed-in side of a vertical strut or a divider of one of the virtually represented wall panels, but is within that junction box's location tolerance of a foamed-in side of a vertical strut or a divider, then the junction box is considered close enough to the respective vertical strut or divider, but if not, the goal is to be able to adjust the layout of virtual wall panels so as to be able to manipulate the locations of the junction boxes (within allowable tolerances) relative to the closest vertical strut or divider of one of the virtually represented wall panels so that an overall complexity level of the entire wall or room is minimized.

In furtherance of this objective, one of the virtually represented wall panels is then removed and the remaining virtually represented wall panels are redistributed along the representation of the wall span in a manner that maximizes the number of junction boxes along the wall span that are at, or within each junction box's tolerance of, a foamed-in side of a vertical strut or a divider of one of the remaining virtually represented wall panels. Then, it is determined whether any of the remaining virtually represented standard-length wall panels would include at least one junction box that is to be exposed on a first surface of the wall span and at least one other junction box that is to be exposed on a second, opposite surface of the wall span.

Each remaining virtually represented standard-length wall panel is then assigned a manufacturing complexity level, based on the manufacturing complexity level rubric described above. The number of remaining virtually represented standard-length wall panels at each manufacturing complexity level is multiplied by their respective manufacturing complexity level, and the total is an improved cumulative manufacturing complexity level for the set of virtually represented standard-sized wall panels.

The process of removing one of the virtually represented standard-length wall panels, redistributing the remaining virtually represented standard-length wall panels so as to maximize the number of junction boxes at, or within tolerance of, a foamed-in side of a vertical strut or divider of one of the remaining virtually represented standard-length wall panels, and calculating an improved cumulative manufacturing complexity level is repeated until a difference of the previous cumulative manufacturing complexity level from the newly-calculated improved manufacturing complexity level is less than 1, at which point the last-removed virtually represented standard-length wall panel is added back and the virtually represented standard-length wall panels are returned to their distribution along the wall panel prior to removal of the last-removed virtually represented standard-length wall panel. However, if it is the case that one or more of the junction boxes, after factoring in the horizontal location tolerance, is located across two virtually represented standard-length wall panels, and the virtually represented standard-length wall panels cannot be redistributed in a manner such that no junction boxes are located across two virtually represented standard-length wall panels, then a virtually represented standard-length wall panel is again removed, and the process continues until no junction boxes are located across two virtually represented standard-length wall panels or there are no remaining virtually represented standard-length wall panels.

Next, for each of the virtually represented standard-length wall panels in the wall span, the wall panel is assigned a version, depending on such factors as whether the wall panel is to be entirely foamed-in or is to have an integral chase region and a foamed-in region, separated by a divider, the number and position(s) of junction boxes, if any, to be pre-installed in the wall panel, and from which surface of the wall panel an electrical outlet, light switch, or other equipment to be accommodated by each such junction box is to be accessed. A number of each version of standard-length wall panels in the wall span is then determined.

The number of each version of standard-length wall panels in the wall span may then be used for such purposes as estimating cost of the wall span, assessing materials necessary for the manufacture of all of the standard-length wall panels in the wall span, and developing a manufacturing plan that includes identifying the number of manufacturing streams dedicated to manufacturing each version.

It is recognized that in identifying the number of manufacturing streams dedicated to manufacturing each version of standard-length wall panel for the wall span, several versions of standard-length wall panels share common features, so certain manufacturing streams may be upstream of others. For instance, a number of standard-length wall panels, with a foamed in portion and a chase region, separated by a vertical divider located at a predetermined uniform distance from a first of the vertical side struts of the wall panel, sufficient to satisfy the common structural requirements of most, if not all, versions may be assembled in a first manufacturing stream.

A number of semi-finished standard-length wall panels completed at the first manufacturing stream that corresponds to the number of standard-length wall panels of various combinations of other versions of standard-length wall panels that share common specifications or attributes are transferred to a second manufacturing stream. For instance, a number of semi-finished standard-length wall panels completed at the first manufacturing stream that are also to have at least one junction box at a standard default height attached on a foamed-in side of a first vertical side strut, to be accessible from a first surface of a wall span to be partially formed by the wall panel, are transferred to a second manufacturing stream. In that second manufacturing stream, in each such transferred wall panel, a junction box would be installed at a standard default height along a foamed-in side of a first of the vertical side struts, open in a direction so as to be accessible from the first surface of a wall span partially formed by the wall panel.

A number of semi-finished standard-length wall panels completed in that second manufacturing stream corresponding to the number of standard-length wall panels of a yet another version or versions, such as wall panels intended to also have a second junction box to be accessible from that same first surface of the wall panel and attached, at a standard default height, on a foamed-in side of a divider separating a chase region from a foamed-in region of the wall panel, would then be transferred to a third manufacturing stream. In each such wall panel transferred to that third manufacturing stream, a second junction box would then be installed at a standard default height along a foamed-in side of the divider, open in a direction so as to be accessible from the first surface of the wall span partially formed by the wall panel.

A number of semi-finished standard-length wall panels completed in the second manufacturing stream corresponding to the number of standard-length wall panels of one or more other versions of the panels, with specifications or attributes common to one another but inconsistent with one or more specifications or attributes of wall panels in the third manufacturing stream, would be transferred to a fourth manufacturing stream. For each such wall panel transferred to that fourth manufacturing stream, additional manufacturing operations would be performed to achieve those common specifications or attributes among those wall panels but inconsistent with one or more specifications or attributes of wall panels in the third manufacturing stream. For instance, in the fourth manufacturing stream a second junction box would be installed at a standard default height along a foamed-in side of the divider, open in a direction so as to be accessible from the second, opposite surface of the wall span partially formed by the wall panel.

It is recognized that additional options, such as standard-length wall panels with junction boxes at a standard height for light switches accessible from either the first surface of the wall span or the second surface of the wall span, with no, one, or two additional junction boxes at the standard default height along a foamed in side of a second vertical strut or divider of the standard-length wall panel, could be added to the matrix of possible wall panel combinations, with additional versions, and manufacturing streams, factored in to accommodate various combinations of wall panels with junction boxes for a light switch and for electrical outlets, accessible from the desired surface of the wall span partially formed by the wall panel.

In a final manufacturing operation, wall panels of each distinct version can be delivered to one or more downstream stations in which skins or shells are applied to the wall panels.

### BRIEF DESCRIPTION OF THE DRAWINGS

FIG. 1 is a floorplan or layout of a plurality of rooms to be defined by wall panels;

FIG. 2 is a version of the floorplan or layout of FIG. 1, with schematic representations of proposed locations of junction boxes within the rooms to be defined by wall panels;

FIG. 3 is an orthogonal view of a wall panel including a frame and an entirely foamed-in core;

FIG. 4 is an orthogonal view of a wall panel similar to that of FIG. 3, but including a vertical tongue or projecting rib along an outer edge of one side of the frame and a vertical groove or channel along an outer edge of an opposite side of the frame, sized to securely receive a tongue or projecting rib of an adjacent wall panel;

FIG. 5 is an orthogonal view of a wall panel including a frame and a vertical divider, separating an interior of the frame into an open chase region and a foamed-in region;

FIG. 6 is an orthogonal view of a wall panel similar to that of FIG. 5, and including a tongue and groove similar to the wall panel of FIG. 4;

FIG. 7 illustrates a virtual representation of one wall span of the floorplan or layout of FIG. 2, adjacent a virtual representation of a plurality of standard-length wall panels that would fit within the length of the wall span, aligned in parallel with the virtual representation of the wall span;

FIG. 8 illustrates a virtual representation similar to FIG. 7, but with the plurality of virtually-represented standard-length wall panels superimposed on the virtually-represented wall span;

FIG. 9 illustrates a virtual representation of the wall span and plurality of standard-length wall panels similar to that of FIG. 7, but illustrating the virtually-represented standard-length wall panels redistributed in a manner that, when the horizontal position along the wall span of each junction box is adjusted along within the horizontal location tolerance of that junction box, maximizes the number of the junction boxes immediately adjacent a foamed-in side of a strut of one of the virtually-represented wall panels, or if the wall panels are of the type with a divider and chase region as illustrated in FIGS. 5 and 6, immediately adjacent a foamed-in side of a strut or a foamed-in side of the divider;

FIG. 10 illustrates a virtual representation similar to FIG. 7, but with the plurality of virtually-represented standard-length wall panels superimposed on the virtually-represented wall span;

FIG. 11 illustrates a virtual representation of the wall span and plurality of standard-length wall panels similar to that of FIG. 7, but illustrating the virtually-represented standard-length wall panels decremented by 1 relative to the number of virtually-represented standard-length wall panels depicted in FIG. 7;

FIG. 12 illustrates a virtual representation of the wall span and plurality of standard-length wall panels similar to that of FIG. 11, but illustrating the virtually-represented standard-length wall panels redistributed in a manner that, when the horizontal position along the wall span of each junction box is adjusted along within the horizontal location tolerance of that junction box, maximizes the number of the junction boxes immediately adjacent a foamed-in side of a strut of one of the virtually-represented wall panels, or if the wall panels are of the type with a divider and chase region as illustrated in FIGS. 5 and 6, immediately adjacent a foamed-in side of a strut or a foamed-in side of the divider;

FIG. 13 illustrates a virtual representation similar to FIG. 12, but with the plurality of virtually-represented standard-length wall panels superimposed on the virtually-represented wall span;

FIG. 14 illustrates a virtual representation of the wall span and plurality of standard-length wall panels similar to that of FIG. 7, but illustrating the virtually-represented standard-length wall panels decremented by 1 relative to the number of virtually-represented standard-length wall panels depicted in FIG. 11, and redistributed in a manner that when the horizontal position along the wall span of each junction box is adjusted along within the horizontal location tolerance of that junction box, maximizes the number of the junction boxes immediately adjacent a foamed-in side of a strut of one of the virtually-represented wall panels, or if the wall panels are of the type with a divider and chase region as illustrated in FIGS. 5 and 6, immediately adjacent a foamed-in side of a strut or a foamed-in side of the divider;

FIG. 15 illustrates a virtual representation similar to FIG. 14, but with the plurality of virtually-represented standard-length wall panels superimposed on the virtually-represented wall span;

FIG. 16 illustrates a virtual representation similar to FIG. 14, but with the position of some of the junction boxes repositioned within their horizontal location tolerance;

FIG. 17 is a schematic diagram of a conventional panel production-to-installation workflow, indicating a typical sequence in which panels are manufactured, randomly finished and packaged, transported to a remote installation site, unloaded, and sequentially installed; and

FIG. 18 is a schematic diagram of a workflow for manufacturing a plurality of wall panels for installation at a remote installation site, utilizing a sequencing methodology of the present disclosure.

### DETAILED DESCRIPTION

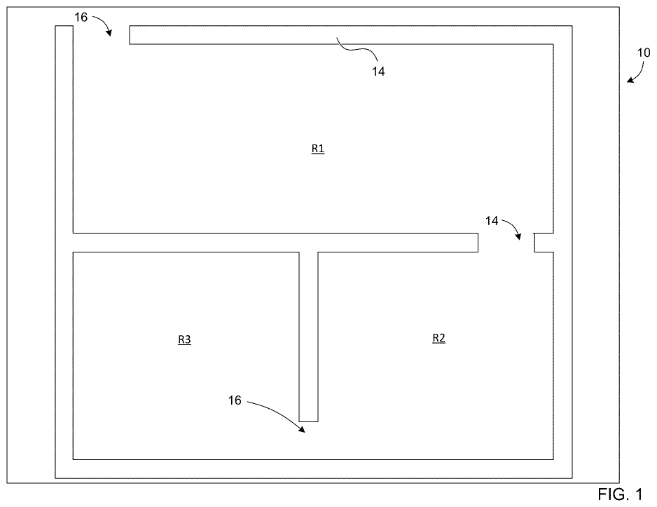

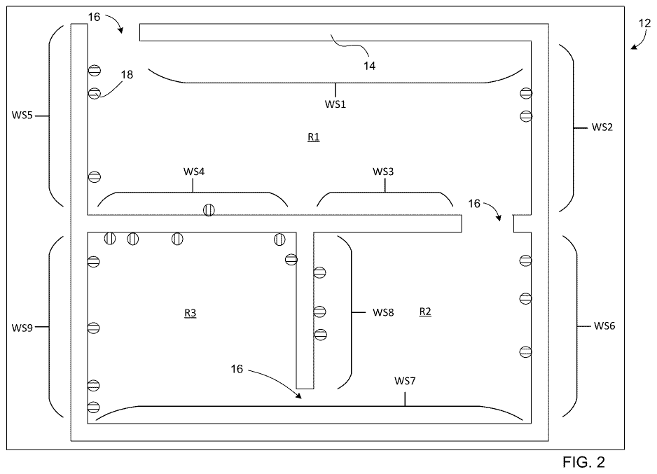

When planning a wall panel installation, the entity or entities involved in ordering the necessary wall panels, manufacturing those wall panels, shipping the wall panels to the jobsite, preparing the wall panels for installation, and installing the wall panels, is typically provided with a layout or floorplan 10, depicting a general plan of the rooms R1, R2, R3 and the walls 14 and doorways 16 separating those rooms, such as the layout or floorplan illustrated in FIG. 1. Other windows, stairwells, elevator shafts, bay doors, counters, or similar interruptions in a given wall may also be represented in the layout or floorplan 10. The desired locations of electrical outlets, light switches, data panels, HVAC, and plumbing, for each of the rooms are also depicted, either on the same floorplan 10 or on a supplemental version of the floorplan 12, such as illustrated in FIG. 2.

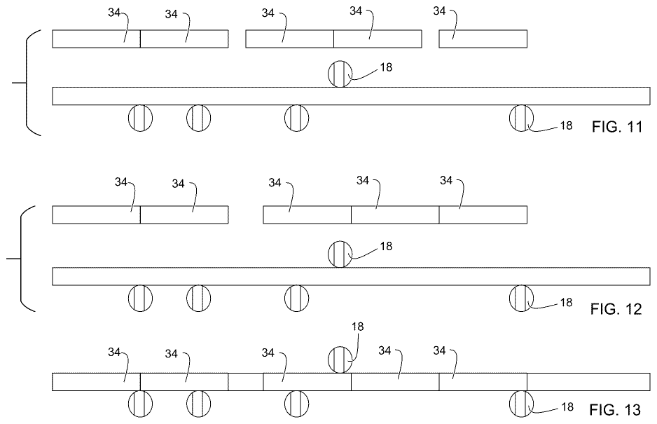

The layout is then analyzed to identify each wall span, which is a segment of wall depicted in the layout from a first corner to the next-closest corner or other interruption along that wall, regardless of which side of the wall that corner or interruption appears. So wall span WS1 extends along a first wall in room R1 of the layout 12. Wall span WS2 extends from one corner (at the upper right of FIG. 12) to a corner at the lower right side of room R1 in the layout 12 of FIG. 2 adjacent a doorway 16 between room R1 and room R2. Wall span WS3 extends from the other side of that doorway 16 to a corner at a wall separating rooms R2 and R3. Wall span WS4 extends from another side of that wall separating rooms R2 and R3 to a corner at the lower left side of room R1 in FIG. 2. Wall span WS5 extends from that same corner to the corner at the upper left side of room R1 in FIG. 2. Wall spans WS6, WS7, and WS8 define the rest of room R2, with wall span WS7 continuing along both rooms R2 and R3, ending at a corner at the lower left of the depiction of room R3 in the layout 12 of FIG. 2.

Junction boxes 18 are illustrated along several of the wall spans WS2, WS4, WS5, WS6, WS8, and WS9. Each of the junction boxes 18 represents the location of an electrical outlet or a light switch. The junction boxes 18 that are depicted in the layout 12 and intended for accommodating electrical outlets may be intended to be mounted at a standard electrical outlet height, which may uniformly be 12″, 16″, or 18″, in a manner consistent with local building codes or preferences. One or more of the junction boxes 16 intended for accommodating an electrical outlet may be intended to be mounted at a non-standard height. Junction boxes 16 intended for accommodating light switches may be intended to be mounted at a standard light switch height, which may be in a range of 44″ to 48″. Cam locks or other hardware (not shown) may additionally or alternatively be used to secure adjacent wall panels to one another. While junction boxes 18 are described as an example of a feature to be incorporated into a wall span, a variety of other specific electrical, HVAC, and/or plumbing conduits or components may require special operations or configuration requirements that need to be considered when planning wall installation, and the principles disclosed herein can be applied equally to such other features.

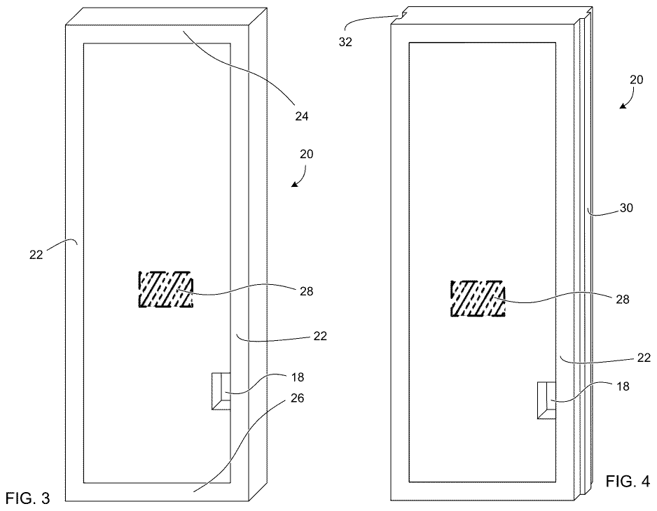

As illustrated in FIG. 3, a wall panel 20 is formed of a frame including two vertical struts 22, a top bar 24 and a bottom bar 26. Wall panels may have a foamed-in core 28. Turning to FIG. 4, to facilitate secure connections between, and maintain alignment of, adjacent wall panels 20, one of the vertical struts 22 may be provided with a projecting rib or tongue 30, and the other vertical strut 22 may be provided with a complementary groove 32 to securely receive the tongue 30 of an adjacent wall panel 20.

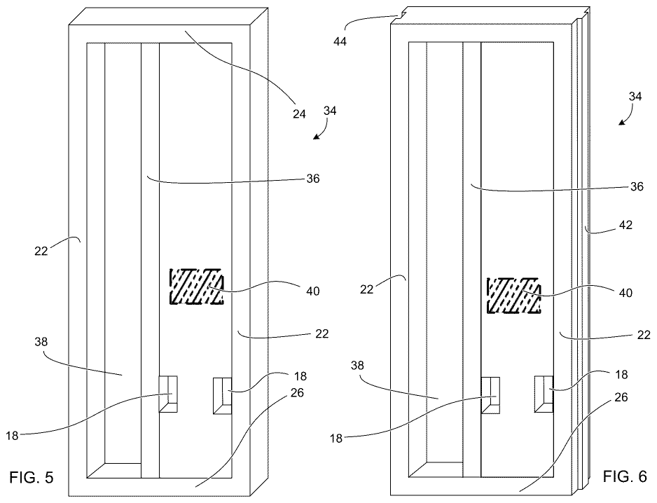

Similar varieties of a preferred wall panel 34 are illustrated in FIGS. 5 and 6, with a default that each of the wall panels has a uniform width, such as 47″, with a chase region 38 uniformly positioned, as illustrated in FIGS. 5 and 6, such that when users look at any of the competed wall spans WS1 thru WS9, they would be able to determine where the chase regions are (i.e., the left 1/3 of each wall panel 34) without being able to see through the wall panel 34. Wall panels 34 have frames with vertical struts 22, a top bar 24, and a bottom bar 26. However, instead of a completely foamed-in core 28, the wall panel 34 includes a divider 36 separating the frame into an open chase region 38 (which can accommodate conduits, plumbing, shelving reinforcements, or other post-installation modifications), and a foamed-in region 40. As illustrated in FIG. 6, the wall panel 34 may include a tongue 42 along one of the vertical side struts 22 and an elongated channel or groove 44 along the other vertical side strut 22. By uniformly positioning the open chase region 38 on a particular side of the wall panel 34, such as the left side of the wall panel 34 as it appears in FIGS. 5 and 6, and in particular, for wall panels 34 having the tongue-and-groove configuration such as illustrated in FIG. 6, once all wall spans WS1-WS9 of the rooms R1 thru R3 are fully constructed using the wall panels 34, even after skins are provided on each of the wall panels 34, one can still easily identify on which side of each of the wall panels 34 the chase region 38 is positioned. For instance, the chase region 38 may always be adjacent a “tongue side” of the wall panel 34, or alternatively, may always be adjacent a “groove side” of the wall panel 34. So long as it can be determined where the “groove side” and the “tongue side” of a particular wall panel 34 are located, and each wall panel 34 is manufactured with an open chase region 38 in the same position relative to one of those sides, even with the wall panel 34 secured to adjacent wall panels 34, one can be confident as to the location of the chase region 38 behind the skin of the wall panel 34, thereby improving the forward compatibility of the wall panel 34 (i.e., to facilitate post-assembly addition of electrical components or conduit to the wall panel 34 in finished rooms R1-R3). In other words, by positioning the chase region 38 of each wall panel 34 consistently throughout the span of a wall or room, end users will know the location of each chase region 38 (for example, the left 1/3 of the panel), without having line-of-sight to the inside of the panel, when they have a need or desire to access the chase region 38 to perform work on the wall panel 34 after installation, such as to add a junction box 18.

Efficiencies in manufacturing a plurality of wall panels to construct the walls of the rooms R1 thru R3 are maximized by using as many standard-length wall panels as possible, but there are limiting factors beyond the lengths of the wall spans WS1-WS9, particularly if junction boxes 18 are to be pre-installed in the wall panels 20, 34 prior to assembly of the walls. Junction boxes 18 that accommodate electrical outlets or light switches are preferably mounted to vertical struts 22 on a foamed-in side thereof. In the case of wall panels 34 such as the varieties illustrated in FIGS. 5 and 6, the foamed-in side of the divider 36 is another preferred location for mounting a pre-installed junction box 18.

Each of the junction boxes 18 has a horizontal location tolerance, or extent to which the location of the junction box 18 could be moved along its respective wall and still be acceptable to the architect, electrician, building inspector, and/or the ultimate customer for whom the project is to be constructed. The horizontal location tolerances may vary from room to room or from junction box to junction box. For example, a given room R2 may have only general requirements as to the presence of a given number, and distribution, of electrical outlets in a room, and therefore a relatively loose horizontal location tolerance, while another room R3 may have very specific location requirements, such as a room intended for use as a multi-cubicle office suite, requiring dedicated electrical outlets at specific locations along the wall where each cubicle is to be located, therefore calling for a tighter horizontal location tolerance for the junction boxes 18.

Some junction boxes 18 may be intended to be accessible from both opposing surfaces of a shared wall separating two rooms. Where the horizontal location tolerance of each given junction box 18 is dependent upon the room from which the electrical outlet accommodated by the junction box 18 is to be accessible, and the tolerances for the horizontal location of junction boxes in the two rooms differs, the horizontal location tolerance of such two-sided (or so-called dual-gang) junction boxes 18 would be the tighter tolerance of the two rooms.

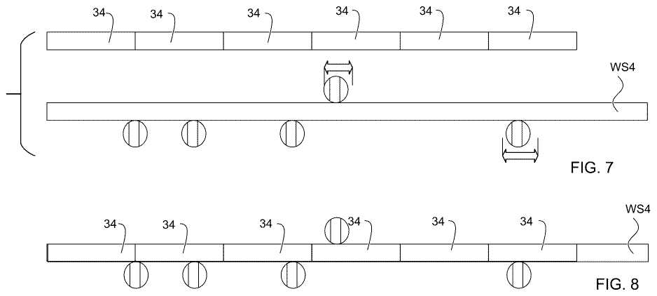

Turning to FIGS. 7 and 8, a virtual representation of one of the wall spans, WS4, is illustrated. The length of the wall span WS4 (after subtracting the length of any special corner wall panels used at either end of wall span WS4) is divided by a standard length for a wall panel, such as 47″. The quotient is rounded down to the nearest whole number, and that number is considered a nominal number of standard-length wall panels 34 that would fit along the wall span WS4.

As illustrated in FIG. 7, the nominal number of standard-length wall panels 34 for wall span WS4 in this example is 6. A virtual representation of the nominal number of standard-length wall panels 34 is depicted. For purposes of clarity, the row of standard-length wall panels 34 in the virtual representation illustrated in FIG. 7 is shown above a virtual representation of the wall span WS4. The virtual representation of the standard-length wall panels 34 may instead, or in addition, be superimposed on the virtual representation of the wall span WS4, as illustrated in FIG. 8.

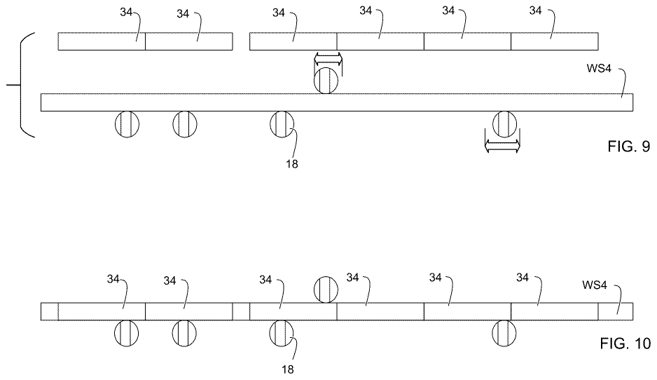

As discussed above, and as illustrated in FIGS. 3, 4, 5, and 6, the preferred location for junction boxes 18 for accommodating electrical outlets in wall panels 20, 34 is on the foamed-in side of the vertical strut 22 or, in the case of a wall panel 34 having a built-in chase region 38, the foamed-in side of the divider 36. A junction box 18 cannot be located where it would intersect two wall panels. As illustrated in FIGS. 9 and 10, the virtually represented standard-length wall panels 34 are then redistributed along the virtual representation of the wall span WS4 in such a manner that maximizes the number of junction boxes 18 that, when positioned in locations within the horizontal location tolerance of each such junction box 18 along the wall span WS4, would be located immediately adjacent the foamed-in side of a vertical strut 22 or the foamed-in side of a divider 36 of one of the virtually represented wall panels 34.

Another limiting condition in a determination of a number and distribution of standard-length wall panels 34 along a wall span WS4 is that the gap, i.e. space between any two adjacent standard-length wall panels 34 which are not touching one another, must be greater than or equal to a minimum length of a non-standard-length wall panel. For instance, in a system where wall panels for use along a wall span are secured to one another with tongue-and-groove connections such as the standard-length wall panels 20, 34 of FIGS. 4 and 6 with tongues 42 and grooves 44, a non-standard-length wall panel must have sufficient length to be provided with a tongue and a groove to mate with adjacent standard-length wall panels 34. Hardware, such as cam locks (not shown) may also be used to interlock adjacent wall panels to one another along a wall span. Non-standard-length wall panels should therefore also have a sufficient length to accommodate such hardware.

Once the standard-length wall panels 34 are distributed along the virtual representation of the wall span WS4 in a manner that maximizes the positioning of junction boxes 18 immediately adjacent the foamed-in side of a vertical strut 22 or the foamed-in side of a divider 36 of one of the virtually represented wall panels 34, a manufacturing complexity score of the virtually-represented wall panel distribution is determined, as summarized in the following Table 1:

TABLE 1

| | | | | | ≥1 JUNCTION | |
|---|---|---|---|---|---|---|
| | | | | | BOX (AT | ≥1 |
| | | | | ≥1 JUNCTION | LEAST ONE OF | JUNCTION |
| | | | | BOX (ALL AT | WHICH NOT AT | BOXES |
| | | | | FOAMED-IN | FOAMED- | ACCESSIBLE |
| | | | | SIDE OF | IN SIDE OF | FROM |
| | | | NO | STRUT OR | STRUT OR | BOTH |
| COMPLEXITY | STD. | | JUNCTION | FOAMED-IN | FOAMED-IN | SURFACES |
| LEVEL | LENGTH? | CHASE | BOXES | DIVIDER) | DIVIDER) | OF PANEL |
| 0 | YES | NO | | | | |
| 1 | YES | YES | 2 | 2 | 1 | 1 |
| 1 | NO | NO | 3 | | | |
| 2 | YES | | | | | |
| 3 | YES | | | | | |
| 4 | YES | | | | | |
| 5 | YES | | | | | |
| 6 | YES | | | | | |

MAUFACTURING COMPLEXITY SCORE = 9

A manufacturing complexity score is essentially a cumulative level of complexity of manufacturing each individual wall panels included in the wall span WS4. A manufacturing complexity level of 0 is indicative of the easiest wall panel to manufacture, which is a wall panel having a standard length (e.g., 47″) and an entirely foamed-in core, with no junction boxes or conduits. A manufacturing complexity level of 1 is indicative of a standard-length wall panel 34 having both a foamed-in core portion and a chase region, separated by a vertical divider a predetermined uniform distance from one of the vertical side struts, e.g., 16 inches, with no junction boxes or conduits, or alternatively, a non-standard length wall panel that is fully foamed-in, such as a wall panel 20 as illustrated in FIG. 3, but having no junction boxes or conduits.

A manufacturing complexity level of 2 is indicative of a standard-length wall panel having one or two junction boxes 18, and if two junction boxes 18, both are to be accessible from the same surface of the wall panel, with each of the junction boxes 18 positioned immediately adjacent a strut 22 on a foamed-in side thereof, or on a foamed-in side of a divider 36.

A manufacturing complexity level of 3 is indicative of a standard-length wall panel having one or more junction boxes that would need to be secured to locations within the wall panel other than a foamed-in side of a strut 22 or a foamed-in side of a divider 36, as other locations for mounting junction boxes 18 may require additional support structure or other modifications to accommodate them.

A manufacturing complexity level of 4 is indicative of a standard-length wall panel having at least two junction boxes 18, at least one of which junction boxes is to be accessible from a first surface of the wall panel (i.e., accessible from a first room partially defined by the wall panel) and at least one other of the junction boxes is to be accessible from a second, opposite surface of the wall panel (i.e., accessible from a second, adjacent room that is also partially defined by the wall panel).

More generally, certain complicating factors can increase the manufacturing complexity level by 1, and other complicating factors can increase the manufacturing complexity level by 2. An example of a complicating factor that would increase the manufacturing complexity level by 1 is a junction box 18 located at a location other than a foamed-in side of a vertical strut 22 or, in the case of a wall panel having both a built-in chase and a foamed-in portion separated by a divider 36, on a foamed-in side of the divider 36. Wall panels having at least two junction boxes 18, one or more of which is to be accessible from a first surface of the wall panel, and at least one other of which is to be accessible from a second, opposite surface of the wall panel, is an example of a complicating factor that would increase the manufacturing complexity level by 2.

With reference to Table 1, above, each of the virtually represented standard-length wall panels 34 depicted in FIG. 10 is evaluated to determine its manufacturing complexity level according to the above-described scoring rubric, the number of non-standard-length and standard-length wall panels 34 satisfying each of the various criteria are added up, multiplied by their respective manufacturing complexity level, and the sum of those is a manufacturing complexity score. Virtually manipulating the arrangement of wall panels 34 along a wall span so as to manipulate the junction box locations provides the feasibility of minimizing an overall complexity level of an entire wall span, so as to optimize manufacturing efficiency and reduce manufacturing costs.

As illustrated in FIGS. 11-16, in an iterative process, the number of standard-length wall panels 34 is then decremented by 1, the remaining virtually represented standard-length wall panels 34 are again redistributed to maximize the number of junction boxes 18 that, when positioned in locations within the horizontal location tolerance of each such junction box 18 along the wall span WS4, would be located immediately adjacent the foamed-in side of a vertical strut 22 or the foamed-in side of a divider 36 of one of the virtually represented wall panels 34. After each such redistribution, a manufacturing complexity score is determined. The manufacturing complexity score for the wall span WS4 to be formed by the virtually represented wall panels of FIG. 13 is reflected in Table 2:

TABLE 2

| | | | | | ≥1 JUNCTION | |
|---|---|---|---|---|---|---|
| | | | | | BOX (AT | ≥1 |
| | | | | ≥1 JUNCTION | LEAST ONE OF | JUNCTION |
| | | | | BOX (ALL AT | WHICH NOT AT | BOXES |
| | | | | FOAMED-IN | FOAMED- | ACCESSIBLE |
| | | | | SIDE OF | IN SIDE OF | FROM |
| | | | NO | STRUT OR | STRUT OR | BOTH |
| COMPLEXITY | STD. | | JUNCTION | FOAMED-IN | FOAMED-IN | SURFACES |
| LEVEL | LENGTH? | CHASE | BOXES | DIVIDER) | DIVIDER) | OF PANEL |
| 0 | YES | NO | | | | |
| 1 | YES | YES | 1 | 1 | 2 | 1 |
| 1 | NO | NO | 1 | | | |
| 2 | YES | | | | | |
| 3 | YES | | | | | |
| 4 | YES | | | | | |
| 5 | YES | | | | | |
| 6 | YES | | | | | |

MANUFACTURING COMPLEXITY SCORE = 6

The calculated manufacturing complexity score is then subtracted from the immediately-preceding calculated manufacturing complexity score. If the difference is at least 1, this reflects an improved manufacturing complexity score, and the iterative process continues. Even if the difference is less than 1, the iterative process may continue if other criteria are still not satisfied, such as if one or more junction boxes 18 would be located across two of the virtually represented standard-length wall panels 34, or if any gap between two of the virtually represented standard-length wall panels 34 is less than a minimum length of a non-standard wall panel.

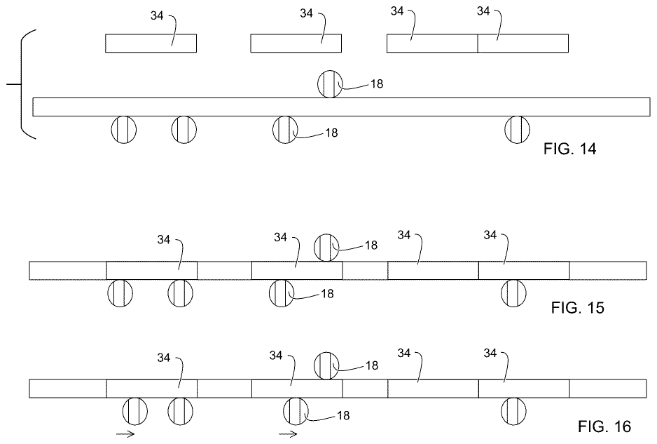

Since the calculated manufacturing complexity score for the virtually represented wall panel number and distribution of FIG. 13, as reflected in Table 2, is less than the immediately-preceding calculated manufacturing complexity score, reflecting an improvement in manufacturing complexity level relative to the number and distribution of virtually represented wall panels of FIG. 10, the iterative process continues, as reflected in FIGS. 14, 15, and 16. The number of virtually represented standard-length wall panels 34 is decremented by 1. The remaining virtually represented standard-length wall panels 34 are then redistributed to again maximize the number of junction boxes 18 that would be located immediately adjacent the foamed-in side of a vertical strut 22 or the foamed-in side of a divider 36 of one of the virtually represented wall panels 34. Adjustments can be made not only to the location along the wall span WS4 of any given standard-length wall panel 34, but also, as illustrated in FIG. 16, the position along the wall span WS4 of each junction box 18 can be moved so long as such movement is within the horizontal location tolerance of that junction box 18.

As in the above-described iterations, the manufacturing complexity score for the wall span WS4 to be formed by the virtually represented wall panels of FIG. 16 is calculated, as reflected in Table 3:

TABLE 3

| | | | | | ≥1 JUNCTION | |
|---|---|---|---|---|---|---|
| | | | | | BOX (AT | ≥1 |
| | | | | ≥1 JUNCTION | LEAST ONE OF | JUNCTION |
| | | | | BOX (ALL AT | WHICH NOT AT | BOXES |
| | | | | FOAMED-IN | FOAMED- | ACCESSIBLE |
| | | | | SIDE OF | IN SIDE OF | FROM |
| | | | NO | STRUT OR | STRUT OR | BOTH |
| COMPLEXITY | STD. | | JUNCTION | FOAMED-IN | FOAMED-IN | SURFACES |
| LEVEL | LENGTH? | CHASE | BOXES | DIVIDER) | DIVIDER) | OF PANEL |
| 0 | YES | NO | | | | |
| 1 | YES | YES | 1 | 1 | 2 | 1 |
| 1 | NO | NO | 1 | | | |
| 2 | YES | | | | | |
| 3 | YES | | | | | |
| 4 | YES | | | | | |
| 5 | YES | | | | | |
| 6 | YES | | | | | |

MANUFACTURING COMPLEXITY SCORE = 6

In comparing the manufacturing complexity score of this latest number and distribution of virtually represented wall panels of FIG. 16 to that of FIG. 13, the difference is 0, reflecting no relative improvement in overall manufacturing complexity would be realized by removing one of the standard-length wall panels 34 and redistributing the remaining standard-length wall panels 34. As such, so long as all other criteria are satisfied, such as that no junction boxes 18 would be located across two of the virtually represented standard-length wall panels 34, and/or no gap between two of the virtually represented standard-length wall panels 34 would be less than a minimum length of a non-standard wall panel, then the iterative process is stopped. The last-removed virtually-represented standard-length wall panel 34 is restored, as is the distribution of standard-length wall panels 34 that maximized the number of junction boxes 18 which would be located immediately adjacent the foamed-in side of a vertical strut 22 or the foamed-in side of a divider 36 of one of the virtually represented wall panels 34 prior to removal of that last-removed virtually-represented standard-length wall panel 34.

This process is repeated for all wall spans for the layout or floorplan 12. A wall panel layout may then be generated based on the final wall panel arrangement for each of the wall spans. With the number and distribution of standard-length wall panels 34 and non-standard length wall panels to be used in defining each wall span of the layout or floorplan 12, an assessment is made of the number of each version of wall panels to be manufactured to physically assemble each of the wall spans.

A first version is a standard-length wall panel 20 that is entirely foamed in.

A second version is a standard-length wall panel 34 that includes a chase region 38 and a foamed in portion 40, separated by a vertical divider 36 located at a predetermined uniform distance from a first of the vertical side struts 22 of the wall panel, and no junction boxes.

A third version is a standard-length wall panel 34 that includes a chase region 38 and a foamed in portion 40, separated by a vertical divider 36 located at a predetermined uniform distance from a first of the vertical side struts 22 of the wall panel 34, and one junction box 18 located at a standard default height (for an electrical outlet) along a foamed in side of a second of the vertical side struts 22, which junction box 18 is open in a direction so as to be accessible from a first surface of the wall span.

A fourth version is a standard-length wall panel 34 that includes a chase region 38 and a foamed in portion 40, separated by a vertical divider 36 located at a predetermined uniform distance from a first of the vertical side struts 22 of the wall panel 34, and one junction box 18 located at a standard default height along a foamed in side of the divider 36, which junction box 18 is open in a direction so as to be accessible from the first surface of the wall span.

A fifth version is a standard-length wall panel 34 that includes a chase region 38 and a foamed in portion 40, separated by a vertical divider 36 located at a predetermined uniform distance from a first of the vertical side struts 22 of the wall panel, and one junction box 18 located at a standard default height along a foamed in side of a second of the vertical side struts 22, which junction box 18 is open in a direction so as to be accessible from a second surface of the wall span, opposite the first surface.

A sixth version is a standard-length wall panel 34 that includes a chase region 38 and a foamed in portion 40, separated by a vertical divider 36 located at a predetermined uniform distance from a first of the vertical side struts 22 of the wall panel 34, and one junction box 18 located at a standard default height along a foamed in side of the divider 36, which junction box 18 is open in a direction so as to be accessible from the second surface of the wall span.

A seventh version is a standard-length wall panel 34 that includes a chase region 38 and a foamed in portion 40, separated by a vertical divider 36 located at a predetermined uniform distance from a first of the vertical side struts 22 of the wall panel, with one junction box 18 located at a standard default height along a foamed in side of a second of the vertical side struts 22, which junction box 18 is open in a direction so as to also be accessible from the first surface of the wall span, and another junction box 18 located at a standard default height along a foamed in side of the divider 36, which junction box 18 is open in a direction so as to also be accessible from the first surface of the wall span.

An eighth version is a standard-length wall panel 34 that includes a chase region 38 and a foamed in portion 40, separated by a vertical divider 36 located at a predetermined uniform distance from a first of the vertical side struts 22 of the wall panel, with one junction box 18 located at a standard default height along a foamed in side of a second of the vertical side struts, which junction box 18 is open in a direction so as to be accessible from the first surface of the wall span, and another junction box 18 located at a standard default height along a foamed in side of the divider 36, which junction box 18 is open in a direction so as to be accessible from the second surface of the wall span.

A ninth version is a standard-length wall panel 34 that includes a chase region 38 and a foamed in portion 40, separated by a vertical divider 36 located at a predetermined uniform distance from a first of the vertical side struts 22 of the wall panel 34, with one junction box 18 located at a standard default height along a foamed in side of a second of the vertical side struts 22, which junction box 18 is open in a direction so as to be accessible from the second surface of the wall span, and another junction box 18 located at a standard default height along a foamed in side of the divider 36, which junction box is open in a direction so as to be accessible from the first surface of the wall span.

A tenth version is a standard-length wall panel 34 that includes a chase region 38 and foamed in portion 40, separated by a vertical divider 36 located at a predetermined uniform distance from a first of the vertical side struts 22 of the wall panel 34, with one junction box 18 located at a standard default height along a foamed in side of a second of the vertical side struts 22, which junction box 18 is open in a direction so as to be accessible from the second surface of the wall span, and another junction box 18 located at a standard default height along a foamed in side of the divider, which junction box 18 is open in a direction so as to also be accessible from the second surface of the wall span.

Based on the number of each version of wall panel determined using the above-described process to complete an entire job, an assessment can be made of the cost of materials necessary to manufacture the wall panels. The assessment may also include estimated labor costs to manufacture the quantity of each version of the wall panels. That assessment may be used for a variety of purposes, such as (1) providing a quotation to a customer as to the materials, labor, and other costs of manufacturing the wall panels necessary to complete the job; (2) ordering materials for the manufacture of the wall panels; and (3) scheduling labor to perform the manufacture of the wall panels.

Economies in the manufacture of the wall panels can be achieved by developing manufacturing streams based on shared specifications or attributes of wall panels to be manufactured. For instance, as summarized in the following Table 4, various manufacturing streams can be developed in which identical operations can be performed repeatedly, without having to accommodate performing non-standardized operations within that particular manufacturing stream. Based on the number of each different version of wall panel called for in the assembly of a particular job, and the common specifications or attributes of various combinations of those versions, each stream in a manufacturing process can be predicted, and adequately provided with supplies and staffing.

TABLE 4

| | | | 1 | 1 | 1 | 1 | |
|---|---|---|---|---|---|---|---|
| | | | JUNCTION | JUNCTION | JUNCTION | JUNCTION | |
| | | | BOX AT | BOX AT | BOX AT | BOX AT | |
| | | | FOAMED- | FOAMED- | FOAMED- | FOAMED- | |
| | | | IN SIDE | IN SIDE | IN SIDE | IN SIDE | |
| | | | OF | OF | OF | OF | |
| | | | STRUT, | STRUT, | DIVIDER | DIVIDER | |
| | | | ACCESSIBLE | ACCESSIBLE | ACCESSIBLE | ACCESSIBLE | |
| | | | FROM | FROM | FROM | FROM | |
| | | | FIRST | SECOND | FIRST | SECOND | |
| | | NO | SURFACE | SURFACE | SURFACE | SURFACE | |
| | | JUNCTION | OF WALL | OF WALL | OF WALL | OF WALL | MFG. |
| VERSION | CHASE? | BOXES | PANEL | PANEL | PANEL | PANEL | STREAMS |
| 1 | NO | X | | | | | |
| 2 | YES | X | | | | | 1 |
| 3 | YES | | X | | | | 1, 2 |
| 4 | YES | | | | X | | 1, 3 |
| 5 | YES | | | X | | | 1, 4 |
| 6 | YES | | | | | X | 1, 5 |
| 7 | YES | | X | | X | | 1, 2, 3 |
| 8 | YES | | X | | | X | 1, 2, 5 |
| 9 | YES | | | X | X | | 1, 4, 3 |
| 10 | YES | | | X | | X | 1, 4, 5 |

All standard-length wall panels 34 of versions 2 thru 10 can be at least partially manufactured in a first manufacturing stream. Because each of versions 3, 7, and 8 include a junction box 18 attached at a foamed-in side of a strut 22, accessible from a first surface of the wall panel 34, once operations in that first manufacturing stream are completed on a number of wall panels 34 corresponding to all of the version 3, 7, and 8 wall panels 34 to be manufactured for the job can then be delivered to a second manufacturing stream in which the junction boxes 18, at the appropriate position and access orientation, can be installed.

Once operations in the second manufacturing stream are completed on a number of standard-length wall panels 34 corresponding to the total number of version 7 wall panels required for a given job, that number of wall panels 34 can then be moved from an end of the second manufacturing stream to a third manufacturing stream, in which a junction box 18 is attached to each wall panel 34 at a standard height on a foamed-in side of a divider 36 of the wall panel 34, accessible from the first surface of the wall panel 34.

Once operations in the first manufacturing stream are completed number of wall panels 34 corresponding to the total number of version 4 wall panels, plus the total number of version 9 wall panels, that number of wall panels 34 can then be moved from an end of the first manufacturing stream to the same third manufacturing stream, to each receive a junction box 18 attached at a standard height on a foamed-in side of a divider 36 of the wall panel 34, accessible from the first surface of the wall panel 34. Once operations in the third manufacturing stream are completed on a number of standard-length wall panels 34 corresponding to the total number of version 9 wall panels required for a given job, that number of wall panels 34 can then be moved from an end of the third manufacturing stream to a fourth manufacturing stream, in which a junction box 18 is attached at a standard height on a foamed-in side of a strut 22 of the wall panel 34, accessible from the second surface of the wall panel 34.

Once operations in the first manufacturing stream are completed number of wall panels 34 corresponding to the total number of version 5 wall panels, plus the total number of version 10 wall panels, that number of wall panels 34 can then be moved from an end of the first manufacturing stream to the fourth manufacturing stream, to also receive a junction box 18 attached at a standard height on a foamed-in side of a strut 22 of the wall panel 34, accessible from the second surface of the wall panel 34.

A number of wall panels 34 corresponding to the number of version 6 panels to be manufactured for the job are moved from the first manufacturing stream (once the manufacturing operations in the first manufacturing stream are completed on those wall panels) to a fifth manufacturing stream. In that fifth manufacturing stream, a junction box 18 is attached at a standard height on a foamed-in side of a divider 36 of the wall panel 34, accessible from the second surface of the wall panel 34. Similarly, a number of wall panels 34 corresponding to the number of version 8 panels to be manufactured for the job are moved from the second manufacturing stream to the fifth manufacturing stream, and a number of wall panels 34 corresponding to the number of version 10 panels to be manufactured for the job are moved from the fourth manufacturing stream to the fifth manufacturing stream, to also receive a junction box 18 attached at a standard height on a foamed-in side of a divider 36 of the wall panel 34, accessible from the second surface of the wall panel 34.

In a final stage, skins or shells are applied to the wall panels 34 and the completed wall panels 34 can then be pooled into each respective version and staged so as to be palletized for transportation to a job site in a manner that facilitates installation of the wall panels 34 at the job site.

The wall panel layout generated based on the final wall panel arrangement for each of the wall spans may advantageously be used to provide an installer with a planogram or installation instruction guide indicating an order in which wall panels are to be installed. Rather than having to open all skids at a jobsite, spend time, and use limited space, to remove and stage all wall panels for one or more wall spans for a given room, the wall panel layout may further be used as a packaging layout guide, indicating at the site of manufacture of the wall panels a reverse order in which individual wall panels are to be stacked on skids, and the skids wrapped for shipment, such that the wall panels are already ordered on the skids in a manner that allows the installer to simply take the uppermost wall panel from a skid and install it directly along the line of the wall to be formed, followed by the next-lower wall panel in that skid, repeating this until all wall panels that were stacked on the skid for shipment have been installed, in the appropriate order, in the wall to be constructed.

If the wall panels are provided with a tongue 42 and groove 44, as illustrated in FIG. 6, these features can be used to help assure the installer positions the wall panel 34 correctly along the wall to be constructed.

By knowing in advance the order in which each of a plurality of wall panels 34 is to be stacked, to facilitate ordered installation of the wall panels 34, additional efficiencies in manufacturing of the wall panel 34 may be realized. For instance, as part of the process of assembling each of the wall panels 34, the materials for each of the individual wall panels may be stacked, or otherwise ordered, in reverse proximity to the order in which the individual wall panels 34 are to be manufactured. By way of example, if each of a plurality of wall panels includes an interior metal structure, an interior wood structure, a frame, and optionally, a foamed-in core in at least a portion of the wall panel, metal materials used at a first station to construct the metal portions, once pre-cut and shaped, can be sequenced in such a manner that the metal portion intended for use in the manufacture of the last of the plurality of wall panels to be installed at the jobsite is positioned at the bottom of a stack of a plurality of the metal portions, each being intended for use in the manufacture of a particular wall panel, with each successively higher metal portion in the stack correlating to a wall panel to be installed earlier in a sequence of wall panels for which the stack of metal portions is intended. A wood portion used at a second station can be sequenced in such a manner that the wood portions intended for use in the manufacture of the first of the plurality of wall panels to be installed at the jobsite is positioned at the bottom of a stack of the plurality of wood portions, each being intended for use in the continued manufacture of particular wall panels, with each successively higher wood portion in the stack correlating to a wall panel to be installed later in the sequence of wall panels for which the stack of wood portions is intended.

The materials can be sequenced such that the last to install wall panel in a sequence of panels is the first wall panel manufactured. Careful planning of the steps to be performed in the manufacture, fabrication, and assembly of individual panels prior to shipment to an installation site can ensure that the last step in the panel production process is performed first on the last wall panel of a given zone, such as a room or a wall to be installed within a room, so that the so-completed panel can be packaged on a pallet deck first, with each preceding panel in a sequence of panels (based on an order in which the wall panels are to be installed at the destination site) is completed with its production, and then stacked for packaging, to the extent practical, on an immediately-succeeding panel to be installed. It is recognized that some relatively small amount of individual panels may have custom, smaller dimensions than most of the other panels, as a result of which it is more practical to stack such smaller custom panels, or pairs of panels, slightly out of the reverse sequence in which the full set of panels in a given stack of panels to be packaged are to be installed, but the relatively smaller dimensions of those custom panels should permit placement of those panels at the installation site in temporary locations that do not significantly detract from the benefits of generally being able to install panels in the order in which they are removed from a packaged skid.

It is also recognized that an overall height of a skid should be such that panels may be removed therefrom by hand, without the need for mechanical assistance, such as with a forklift, since the individual panels should not need to be rearranged after removal from the skid and prior to installation, but rather, can be installed directly, which two installers can generally accomplish manually.

It is further recognized that the sequencing of manufacture of the panels may advantageously be adjusted based on considerations other than an order in which the panels are to be installed. For instance, if a panel manufacturer is relying upon just-in-time manufacturing techniques with respect to its materials necessary for the production of panels, and there are delays in receipt at the panel production facility in certain materials that are necessary for producing panels that are to be installed later in a sequence of panels compared to the materials on hand that may be sufficient for the production, or substantial production, of panels to be installed earlier in a sequence, to mitigate impacts in manufacturing time it may be determined that it is more efficient to first produce the panels for which there are sufficient materials are on hand to manufacture, even though such panels are to be installed earlier in the sequence at the installation site, in which case such panels can be temporarily stacked in a reverse order prior to packaging. As a result, once sufficient materials are received to produce or finish panels that are to be installed later in the sequence at the installation site, those later-to-be-installed panels can then be produced, preferably in a sequential (or substantially sequential) order in which the panels are to be installed. Once the last-to-be-installed panel is produced, it can then be transferred from the temporary stack to the pallet deck or skid. In other words, variations in the sequence of panel production can be made and accommodated prior to packaging, without impacting the efficiencies realized at the installation site to providing skids of panels to be installed in an order that promotes direct panel installation without having to unpackage, transfer, and re-order panels prior to installation.

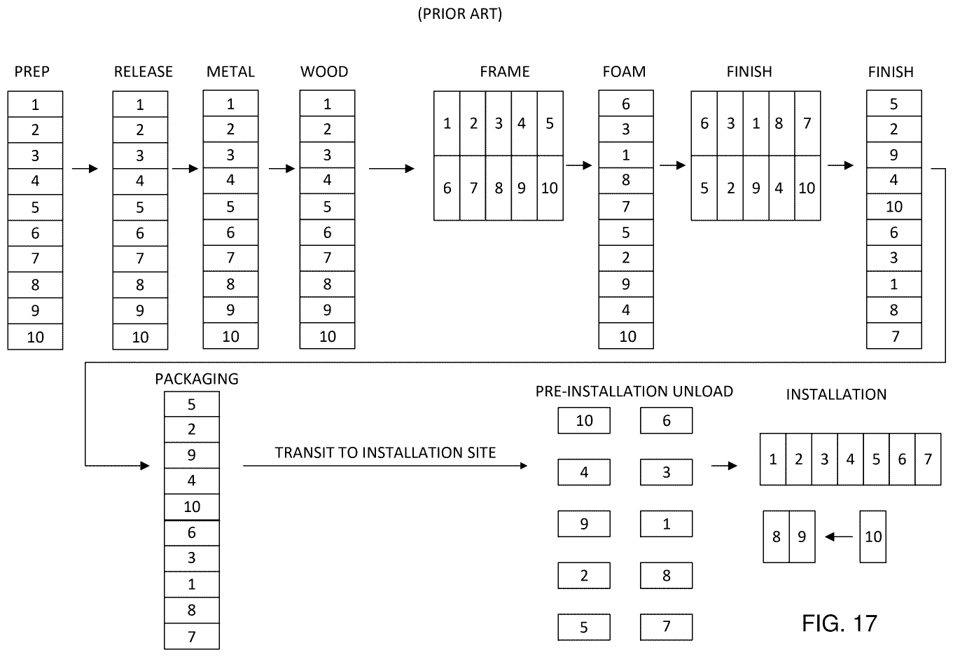

A conventional panel production, finishing, packaging, transportation to installation site, unloading of delivered panels prior to installation, and panel installation is illustrated in FIG. 17. Each numbered rectangle schematically represents an individual wall panel to be installed at the installation site, in a sequence corresponding to the numerical order of the numbered panels. In this example, once produced, ten panels are stacked together on a skid for transportation to the installation site. The inefficiency of this approach is particularly appreciated after delivery to the installation site, as the panel members must be unloaded and separately laid out on the floor (or against one or more already-finished walls, depending on the space constraints of the installation site) to uncover each panel so that the panels can be identified and installed in the correct sequence.

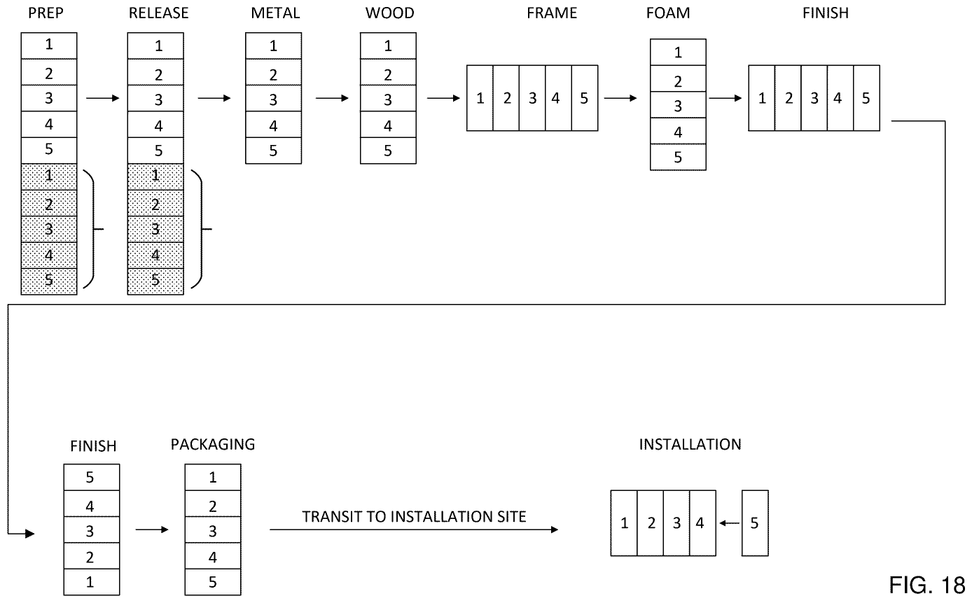

Turning to FIG. 18, the laborious task of unloading and laying out randomly-ordered wall panels is eliminated by producing and loading the wall panels for delivery in a last-in-first-out sequence, such that the uppermost wall panel on a skid or stack of wall panels is the first wall panel to be installed, the wall panel on the skid or stack exposed by removing the uppermost wall panel is the next wall panel to be installed, etcetera. The number of wall panels packaged on a single skid is limited so that an overall height of the wall panels of a given stack or skid is one in which the uppermost wall panel can be removed for installation without the need for a forklift or other mechanical lifting equipment.

In each of the “PREP” and “RELEASE” phases of production, the schematic workflow illustrated in FIG. 18 includes stipple-shaded rectangles 1 thru 5, which represent wall panel-specific materials that are laid out by, for example, machine operators or material prep personnel, so that process materials used in fabricating the individual wall panels is similarly sequenced so as to complement an order in which the panels are to be manufactured.

Use of this sequencing methodology also conserves space at the installation site, as installers only need to open a single skid of panels at a time, instead of having to lay out all panels of one skid, or even of multiple skids, to locate the panels in the order in which they are to be installed. Due to the significant weight of the wall panels, this wall panel production, finishing, packaging, and installation sequencing methodology promotes safety, as handling time is reduced, as is the number of times installers may need to bend over to place panels flat on the ground, rearrange them if needed, to locate the wall panels for installation in the required sequence, and then pick the unloaded wall panels back up, rotate them to a vertical orientation, and move them into position for installation.

Following the sequencing methodology disclosed herein has various additional benefits, such as reduced downtime in both the panel production process and during installation, and tends to result in fewer wall panel defects, attributable to reduced handling of the wall panels.

While various process steps, wall panel configurations, and manufacturing workflows have been described herein, it will be understood that variations may be made thereto that are still within the scope of the appended claims.

What is claimed is:

1. A method for preparing a plurality of wall panels for assembly of one or more rooms, comprising:
receiving a layout or floorplan including dimensions for walls of each of one or more rooms to be constructed of wall panels;
receiving a schematic diagram providing locations of junction boxes to support electrical outlets in one or more of the walls included in the layout or floorplan;
associating with each of the junction boxes identified in the schematic diagram at least a horizontal location tolerance indicative of an extent to which the position of that junction box is movable along a length of the wall from the position in which the junction box is schematically depicted to be located;
identifying each wall span in the layout, each wall span extending from a corner of a wall to a nearest corner on either side of the wall;
for each identified wall span:
determining a length of the wall span;
determining an adjusted wall span length by subtracting from the determined length of the wall span a distance corresponding to
a length of each corner panel member along the wall span and immediately adjacent to one of the corners included in the wall span;
a length of each doorway along the wall span;
a length of each window along the wall span;
a length of each set of elevator doors along the wall span;
a length of each stairwell along the wall span; and
a length of each counter opening along the window span;
determining a number of standard-length wall panels to potentially be included in the wall span by dividing the adjusted wall span length by a standard length of a wall panel to be used in assembling the wall span, and rounding that quotient down to its nearest whole number; then
(a) arranging a virtual representation of the determined number of standard-length wall panels to potentially be included in the wall span in a row along a virtual representation of the wall span to be assembled by the wall panels, each of the standard-length wall panels including a frame having first and second vertical sides struts, a vertical divider between the first and second vertical side struts, an open chase region between the first vertical side strut and the divider and a region between the divider and the second vertical side strut filled in with foam insulation, the virtual representation of the wall span including schematic representations of the locations of any junction boxes along that wall span and the horizontal location tolerance of each of the junction boxes along that wall span;
(b) distributing the virtual representations of wall panels along the virtual representation of the wall span in a manner that, when the horizontal position along the wall span of each junction box is adjusted along within the horizontal location tolerance of that junction box, maximizes the number of the junction boxes immediately adjacent a foamed-in side of the second strut, or a foamed in side of the divider, of one of the virtually represented wall panels;
then, (c) calculating a complexity factor by
assigning each virtually represented wall panel having no junction boxes a manufacturing complexity level of 1;
assigning each virtually represented wall panel having at least one junction box, with each of the at least one junction boxes of that virtually represented wall panel being immediately adjacent a foamed-in side of the second strut, or a foamed in side of the divider, and all of the at least one junction boxes along that virtually represented wall panel being open for access from the same surface of the wall span, a manufacturing complexity level of 2;
assigning each virtually represented wall panel having at least one junction box, with at least one junction boxes of that virtually represented wall panel being at a location along that virtually represented wall panel other than immediately adjacent a foamed-in side of the second strut, or a foamed in side of the divider, and all of the at least one junction boxes along that virtually represented wall panel being open for access from the same surface of the wall span, a manufacturing complexity level of 3; and
assigning each virtually represented wall panel having at least two junction boxes, with at least one junction box of that virtually represented wall panel being at a location along that virtually represented wall panel other than immediately adjacent a foamed-in side of the second strut, or a foamed in side of the divider, and at least one of the at least one junction boxes along that virtually represented wall panel being open for access from a surface of the wall span opposite the surface of the wall span from which at least one other of the junction boxes is open for access, a manufacturing complexity level of 4; and
adding a number of the virtually represented wall panels having a manufacturing complexity level of 1, plus a number of the virtually represented wall panels having a manufacturing complexity level of 2, plus a number of the virtually represented wall panels having a manufacturing complexity level of 3, plus a number of the virtually represented wall panels having a manufacturing complexity level of 4;
then, if the manufacturing complexity level is >1,
(d) updating the number of standard-length wall panels to potentially be included in the wall span by decrementing the number of virtually represented standard-length wall panels to potentially be included in the wall span by 1, then iteratively repeating steps (a), (b), and (c) using the updated number of standard-length wall panels to potentially be included in the wall span, until a difference between the manufacturing complexity level of the updated number of standard-length wall panels to potentially be included in the wall span and the immediately-previously-calculated manufacturing complexity level is <1, then
(e) reverting to the immediately preceding number and distribution of standard-length wall panels to potentially be included in the wall span, determining a number and length(s) of non-standard-length wall panels necessary to fill in any regions of the wall span not occupied by a virtually-represented standard length wall panel of the reverted-to number and distribution of standard-length wall panels, and defining a combination of the reverted-to number and distribution of standard-length wall panels, with the number and length(s) of non-standard length wall panels, as a final wall panel arrangement for the wall span; and
generating a wall panel layout based on the final wall panel arrangement for each of the wall spans.

2. The method of claim 1, and after calculating the complexity factor, determining whether the complexity factor is the lowest possible complexity factor for at least one of the wall spans.

3. The method of claim 1, and in associating with each of the junction boxes identified in the schematic diagram at least a horizontal location tolerance indicative of an extent to which the position of that junction box is movable along a length of the wall from the position in which the junction box is schematically depicted to be located, the horizontal location tolerance of at least one junction box accessible from the first surface of the wall span is tighter than the horizontal location tolerance of at least one junction box accessible from the second, opposite surface of the wall span.

4. The method of claim 1, and if in step (e), a gap between any two adjacent virtually represented standard-length wall panels is less than a minimum non-standard wall panel length, repeating step (d) without repeating step (e).

5. The method of claim 4, and if in step (e), at least one of the junction boxes is located across two of the standard-length wall panels, repeating step (d) without repeating step (e).

6. The method of claim 1, and if in step (e), at least one of the junction boxes is located across two of the standard-length wall panels, repeating step (d) without repeating step (e).

7. The method of claim 1, and (f) identifying a number of each variation of standard-length wall panels to be manufactured based on the final wall panel arrangement for each of the wall spans.

8. The method of claim 7, and after step (f), defining a plurality of manufacturing streams, and in each stream, one or more repetitive operations are performed to meet one or more specifications or attributes of a wall panel common to all variations of standard-length wall panel members to be fed to each respective stream.

9. The method of claim 1, and producing a plurality of wall panels according to the generated wall panel layout with a step of producing each of the wall panels including applying a first skin covering an exterior front side and a second skin covering an exterior back side of the wall panel, then using the produced plurality of wall panels, assembling at least one room by assembling walls of the room according to the wall panel layout based on the final wall panel arrangement for each of the wall spans, wherein, in the assembled room, the open chase region of each wall panel of each assembled wall is uniformly located on the same side of the wall panel in which the open chase region is provided, thereby facilitating determination of open chase region position behind each covered wall panel of each assembled wall.

10. A method of preparing a plurality of wall panels for installation in a particular sequence, comprising:
determining, based on a sequence in which the plurality of wall panels is to be installed, an order in which the wall panels are to be stacked for delivery to an installation site, the determined stacking order being one in which a first of the plurality of wall panels to be installed is a last of the plurality of wall panels to be stacked, and, prior to packaging the plurality of wall panels, producing the plurality of wall panels in an order in which the first of the plurality of wall panels to be installed is a first of the plurality of wall panels produced.

11. The method of claim 10, and in determining the order in which the wall panels are to be stacked for delivery, the determined stacking order further being one in which a last of the plurality of wall panels to be installed is a first of the plurality of wall panels to be stacked.

12. The method of claim 11, and in producing the plurality of wall panels, the production order includes a last of the plurality of wall panels to be installed being a last of the plurality of wall panels produced.

13. The method of claim 11, and in determining the order in which the wall panels are to be stacked for delivery, the determined stacking order further being one in which substantially every wall panel is stacked in a reverse order to the sequence in which the plurality of wall panels is to be installed.

14. The method of claim 13, and in producing the plurality of wall panels, the production order involves producing substantially every wall panel of the plurality of wall panels in an order corresponding to the sequence in which the plurality of wall panels is to be installed.

15. The method of claim 10, further comprising, prior to producing the plurality of wall panels, ordering materials used in producing the individual wall panels in a wall panel-specific order that complements the order in which the wall panels are to be produced.
